(19) United States
(12) Patent Application Publication
(10) Pub. No.: US 2022/0335429 A1
(43) Pub. Date: Oct. 20, 2022

(54) METHODS AND SYSTEMS FOR REDUCING DECLINE RATES OF ELECTRONIC PAYMENT REQUESTS IN CARD-ON-FILE TRANSACTIONS

(71) Applicant: MASTERCARD INTERNATIONAL INCORPORATED, Purchase, NY (US)

(72) Inventors: Gaurav Dhama, Haryana (IN); Hardik Wadhwa, Haryana (IN); Puneet Vashisht, Haryana (IN)

(21) Appl. No.: 17/709,292

(22) Filed: Mar. 30, 2022

(30) Foreign Application Priority Data
Apr. 19, 2021 (IN) 202141018066

(51) Int. Cl. G06Q 20/40; G06Q 20/12; G06Q 20/34

(52) U.S. Cl. CPC G06Q 20/405; G06Q 20/12; G06Q 20/34

(57) ABSTRACT

Embodiments provide methods and systems for reducing decline rates of transaction requests in card-on-file payment transactions. Method performed by server system includes accessing information of a card-on-file payment transaction for a cardholder. The information includes a payment account of the cardholder and a payment amount to be paid to a merchant account of a merchant. Method includes determining a hidden state associated with the cardholder based, at least in part, on a deep Markov model and the payment amount. The deep Markov model is trained based, at least in part, on past customer spending features associated with the cardholder. Method includes predicting a likelihood score of being the card-on-file payment transaction getting approved within a particular time window based, at least in part, on the hidden state associated with the cardholder and providing a notification to the merchant based, at least in part, on the likelihood score.

### CROSS-REFERENCE TO RELATED APPLICATION

This application claims the benefit of, and priority to, Indian Patent Application No. 202141018066 filed on Apr. 19, 2021. The entire disclosure of the above application is incorporated herein by reference.

### FIELD

The present disclosure relates to artificial intelligence processing systems and, more particularly to, electronic methods and complex processing systems for reducing decline rates of electronic payment requests in card-on-file payment transactions.

### BACKGROUND

This section provides background information related to the present disclosure which is not necessarily prior art.

A “card-on-file” transaction is a type of payment transaction in which a merchant stores payment card (e.g., debit cards, credit cards, prepaid cards) information (except CVV number) of cardholders in a database. The merchant retrieves payment card information of a cardholder and initiates at least one payment transaction request based on the payment card information at a later time. One specific implementation of the card-on-file transaction is “recurring payment transaction model”, where the merchant initiates a recurring payment transaction request on a recurring basis for a particular cardholder. Multiple merchants may have stored payment card information for the same cardholder.

In such recurring payment transactions, the merchant retrieves the payment card information of a particular cardholder and initiates the recurring payment transaction request for a particular payment amount based on the payment card information. Sometimes, the recurring payment transaction request is initially declined by a card issuer of the particular cardholder due to insufficient funds in the payment account of the cardholder. In such scenarios, the merchant, after facing transaction decline initially, may retry for the recurring transaction again after some time. Since the merchant does not have any visibility into the funds of the cardholder or the transactions performed by the cardholder for other merchants, the merchant might need to retry the recurring payment transaction multiple times to get the transaction approved, thereby making the process time-consuming.

Further, there is a cost associated with retrying the card-on-file transaction on the part of the merchant. In some example scenarios, the retry counts may go as high as more than 10 in a single month for a large number of merchants which leads to a higher cost for the merchants. Additionally, customers/cardholders may face the disruption of services due to transaction declines, which leads to a bad customer experience.

Thus, there exists a technological need for a technical solution for reducing decline rates of transaction requests in the card-on-file transactions using automated means to an unprecedented manner/degree, through the use of artificial intelligence and machine learning.

### SUMMARY

This section provides a general summary of the disclosure, and is not a comprehensive disclosure of its full scope or all of its features. Aspects and embodiments of the disclosure are set out in the accompanying claims.

Various embodiments of the present disclosure provide systems, methods and electronic devices for predicting a likelihood score of being a card-on-file payment transaction getting approved for a cardholder.

In an embodiment, a computer-implemented method is disclosed. The computer-implemented method performed by a server system includes accessing information of a card-on-file payment transaction for a cardholder. The information includes a payment account of the cardholder and a payment amount to be paid to a merchant account of a merchant. The computer-implemented method includes determining a hidden state associated with the cardholder based, at least in part, on a deep Markov model and the payment amount. The deep Markov model is trained based, at least in part, on past customer spending features associated with the cardholder. The computer-implemented method includes predicting a likelihood score of being the card-on-file payment transaction getting approved within a particular time window based, at least in part, on the hidden state associated with the cardholder. The computer-implemented method further includes providing a notification to the merchant based, at least in part, on the likelihood score.

In another embodiment, a server system is disclosed. The server system includes a communication interface, a memory comprising executable instructions and a processor communicably coupled to the communication interface. The processor is configured to execute the executable instructions to cause the server system to at least access information of a card-on-file payment transaction for a cardholder. The information includes a payment account of the cardholder and a payment amount to be paid to a merchant account of a merchant. The server system is further caused to determine a hidden state associated with the cardholder based, at least in part, on a deep Markov model and the payment amount. The deep Markov model is trained based, at least in part, on past customer spending features associated with the cardholder. The server system is further caused to predict a likelihood score of being the card-on-file payment transaction getting approved within a particular time window based, at least in part, on the hidden state associated with the cardholder. The server system is further caused to provide a notification to the merchant based, at least in part, on the likelihood score.

In yet another embodiment, another computer-implemented method is disclosed. The computer-implemented method performed by a server system includes accessing information of a card-on-file payment transaction for a cardholder. The information includes a payment account of the cardholder and a payment amount to be paid to a merchant account of a merchant. The computer-implemented method includes determining a hidden state associated with the cardholder based, at least in part, on a deep Markov model and the payment amount. The deep Markov model is trained based, at least in part, on past customer spending features associated with the cardholder. The computer-implemented method includes predicting a likelihood score of being the card-on-file payment transaction getting approved within a particular time window based, at least in part, on the hidden state associated with the cardholder. The computer-implemented method further includes providing a notification to the merchant based, at least in part, on the likelihood score. The deep Markov model is a hidden Markov model (HMM) with a variational inference structure, and each hidden state of the hidden Markov model represents a band of probable amount balance available in the payment account.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. For a more complete understanding of example embodiments of the present technology, reference is now made to the following descriptions taken in connection with the accompanying drawings in which:

FIG. 1 is an example representation of an environment, related to at least some example embodiments of the present disclosure;

FIG. 2 is a simplified block diagram of a server system, in accordance with one embodiment of the present disclosure;

FIG. 3 is a schematic block diagram representation of a process flow for training the deep Markov model, in accordance with an example embodiment of the present disclosure;

FIG. 4 is an example representation of a structure of the hidden Markov model, in accordance with an example embodiment of the present disclosure;

FIGS. 5A and 5B, collectively, represent a sequence flow diagram for predicting a likelihood of being a card-on-file payment transaction request getting approved within a particular time window, in accordance with an example embodiment of the present disclosure;

FIG. 6 is a flow diagram of a computer-implemented method for predicting a likelihood score of being a card-on-file payment transaction getting approved, in accordance with another embodiment of the present disclosure;

FIG. 7A shows an example representation of a transmission network model, in accordance with an example embodiment of the present disclosure;

FIG. 7B shows an example representation of an emission network model, in accordance with an example embodiment of the present disclosure;

FIG. 7C shows an example representation of a variational neural network for predicting current emission probability of each hidden state of the deep Markov model, in accordance with an example embodiment of the present disclosure;

FIG. 8 is a simplified block diagram of an electronic device capable of implementing at least some embodiments of the present disclosure; and

FIG. 9 is a simplified block diagram of another electronic device capable of implementing at least some embodiments of the present disclosure.

The drawings referred to in this description are not to be understood as being drawn to scale except if specifically noted, and such drawings are only exemplary in nature. Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure. In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund a financial transaction (interchangeably referred to as “card-on-file payment transaction”). Examples of the financial account include, but are not limited to, a savings account, a credit account, a checking account and a virtual payment account. The financial account may be associated with an entity, such as an individual person, a family, a commercial entity, a company, a corporation, a governmental entity, a non-profit organization, and the like. In some scenarios, a financial account may be a virtual or temporary payment account that can be mapped or linked to a primary financial account, such as those accounts managed by payment wallet service providers, and the like.

The term “payment network”, used herein, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by such as, Mastercard®.

The term “merchant”, used throughout the description generally refers to a seller, a retailer, a purchase location, an organization, or any other entity that is in the business of selling goods or providing services, and it can refer to either a single business location, or a chain of business locations of the same entity.

The term “cardholder” and “customer” are used interchangeably throughout the description and refer to a person who holds a credit or a debit card that will be used by a merchant to perform a card-on-file payment transaction.

The term “card-on-file (COF) transaction”, used throughout the description generally refers to a payment transaction in which the cardholder's payment card is not utilized physically to identify the cardholder's payment card account information, instead the cardholder's payment card account information is stored and recalled at the time of the transaction and therefore attached to the payment transaction for processing through the payment network. For example, in recurring payment transactions, a merchant, such as an online video streaming platform, may have a customer/cardholder's payment card account information on file, which it may use periodically to initiate recurring transactions. The merchant, in this example, may initiate this transaction without the presence of the cardholder's card, through the use of the payment card account information on file.

Various example embodiments of the present disclosure provide methods, systems, user devices and computer program products for reducing decline rates of transaction requests in card-on-file payment transactions or increasing approval rates in card-on-file payment transactions. In most scenarios, the card-on-file decline happens due to insufficient funds availability in cardholder's account. Thus, any prior-determination of funds availability in the cardholder's account may give visibility to merchants about a time when to retry for the card-on-file payment transactions. Moreover, with advanced determination, retrial of card-on-file transactions is only performed when the probability of availability of sufficient funds in cardholder's account is high, thereby reducing the chances of disruption of services for the customer that can lead to bad customer experiences.

In an example, the present disclosure describes a server system that determines a likelihood of getting a card-on-file payment transaction approved within a particular time window. In other words, the server system is configured to determine whether the cardholder's account has a sufficient account balance for the card-on-file payment transaction, or not. The server system includes at least a processor and a memory. In one non-limiting example, the server system is a payment server. When one or more merchants encounter declines for card-on-file payment transactions for a cardholder, the one or more merchants may send a request to the server system for finding an optimal retrial strategy for the card-on-file payment transaction. Based on the request, the server system is configured to access information of a card-on-file payment transaction for a cardholder. The information may include a payment account of the cardholder and a payment amount to be paid to a merchant account of a merchant.

In one embodiment, the server system is configured to utilize a deep Markov model which is trained based, at least in part, on past customer spending features of the cardholder. In one embodiment, the deep Markov model is a hidden Markov model with a variational inference architecture. The customer spending features may include, but not limited to, total spends at one or more merchants, transaction velocities at all aggregate merchants, total spend in the current month, total spend in the previous month, number of declined transactions, total amount requested in declined transactions, total amount requested in declined transactions due to insufficient funds, total spend by each industry, total transactions in each industry, etc. The server system is configured to access all historical transaction data of the cardholder for a particular time duration and generate the customer spending features of the cardholder based on all the historical transaction data.

The server system is configured to determine a hidden state associated with the cardholder based at least in part on the trained deep Markov model and the payment amount. Each hidden state of the deep Markov model represents a band of probable amount balance available in the payment account. Thereafter, the server system is configured to predict a likelihood score of being the card-on-file payment transaction getting approved within the particular time window based, at least in part, on the hidden state associated with the cardholder. More specifically, the server system is configured to predict a current emission probability associated with the hidden state within the particular time window based, at least in part, on a variational neural network model. The variational neural network model is trained based, at least in part, on past latent customer representation and previous emission probabilities associated with a plurality of hidden states. The server system is configured to determine the likelihood score of being the card-on-file payment transaction getting approved based, at least, on the current emission probability associated with the hidden state within the particular time window.

When the likelihood score is greater than the predetermined threshold value, the server system is configured to provide a notification to the merchant including a recommendation for retrying the card-on-file payment transaction from the payment account associated with the cardholder within the particular time window.

In one embodiment, when the likelihood score is not greater than the predetermined threshold value, the server system is configured to determine an optimal time duration in which the likelihood score of being the card-on-file payment transaction getting approved is greater than the predetermined threshold value.

In another embodiment, when the likelihood score is not greater than the predetermined threshold value, the server system is configured to check current emission probabilities associated with one or more hidden states. The one or more hidden states correspond to bands of probable amount balance available in the payment account which are lower than the requested payment amount. The server system is configured to identify a hidden state associated with a current emission probability value greater than the predetermined threshold value, from the one or more hidden states. Then, the server system is configured to provide the notification to the merchant including a recommendation for retrying the card-on-file payment transaction for a partial payment amount which is less than the payment amount in lieu of an entirety of the payment amount.

Various embodiments of the present disclosure offer multiple advantages and technical effects. For instance, the present disclosure provides a system for determining the likelihood of the card-on-file payment transaction getting approved within a particular time window which can be used to decide whether to retry for the card-on-file payment transaction at a particular time window, or not. Further, the merchants get to know beforehand when they should retry for the card-on-file payment transaction, thereby eliminating the need of retrying the transactions after a certain time again and again which further reduces the cost associated with each retrial. The present disclosure helps in improving customer experience by reducing the chances of disruption of services for the customer.

In particular, the present disclosure utilizes dynamic models, such as a deep Markov model that is a variant of hidden Markov models, with a feed-forward neural network to model the conditional probabilities between hidden states of customer behaviour. The deep Markov models are more robust to sudden changes in the time series data. Thus, the deep Markov models can be used for non-stationary time-series data (i.e., time-series data that exhibits a lot of change in a short period of time, such as stock price data, transactional data, etc.).

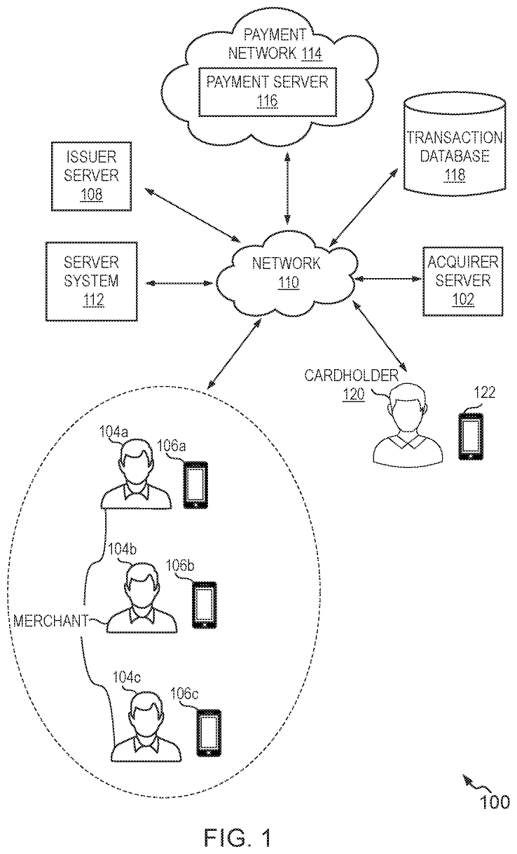

Various example embodiments of the present disclosure are described hereinafter with reference to FIGS. 1 to 9.

FIG. 1 illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, determining an optimal time window for retrying card-on-file (COF) payment transactions so that the COF payment transactions get approved, etc. The environment 100 generally includes a plurality of entities, for example, an acquirer server 102, a plurality of merchant devices 106a, 106b and 106c associated with a plurality of merchants 104a, 104b and 104c, an issuer server 108, a payment network 114 including a payment server 116, and a transaction database 118 each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 110 may include multiple different networks, such as a private network made accessible by the payment network 114 to the acquirer server 102 and the payment server 116, separately, and a public network (e.g., the Internet etc.).

The environment 100 also includes a server system 112 configured to perform one or more of the operations described herein. In one example, the server system 112 is the payment server 116. In general, the server system 112 is configured to identify electronic payment transaction records that have ambiguous merchant data fields (e.g., merchant location). The server system 112 is a separate part of the environment 100, and may operate apart from (but still in communication with, for example, via the network 110) the acquirer server 102, the payment server 116, and any third party external servers (to access data to perform the various operations described herein). However, in other embodiments, the server system 112 may actually be incorporated, in whole or in part, into one or more parts of the environment 100, for example, the payment server 116. In addition, the server system 112 should be understood to be embodied in at least one computing device in communication with the network 110, which may be specifically configured, via executable instructions, to perform as described herein, and/or embodied in at least one non-transitory computer-readable media.

In one embodiment, the acquirer server 102 is associated with a financial institution (e.g., a bank) that processes financial transactions. This can be an institution that facilitates the processing of payment transactions for physical stores, merchants, or an institution that owns platforms that make online purchases or purchases made via software applications possible (e.g., shopping cart platform providers and in-app payment processing providers). The terms “acquirer”, “acquirer bank”, “acquiring bank” or “acquirer server” will be used interchangeably herein.

In one embodiment, the plurality of merchants 104a, 104b, and 104c is associated with the acquirer server 102.

The cardholder 120 may operate a user device 122 to conduct a payment transaction through a payment gateway application. The cardholder 120 may be any individual, representative of a corporate entity, non-profit organization, or any other person that has established a card-on-file relationship with a merchant (e.g., merchant 104a). The cardholder 120 provides payment card information to the merchant, thereby allowing the merchant to periodically charge the cardholder 120 for a product or a service. For example, the cardholder 120 enters the payment card information into a web browser and submits the payment card information to the merchant. Thereafter, the merchant stores the payment card information in a database and/or server. The payment card information used by the merchant may include the cardholder's name as it appears on the payment card, a billing address, an account number or card number of the payment card, and/or an expiration date of the payment card. In other words, the cardholder 120 authorizes the merchant 104a to store the card details of the cardholder 120 and to bill the cardholder 120 for recurring transactions using the stored card details. In one example, the payment transaction request may get approved or declined based on the availability of funds in a payment account associated with the cardholder 120.

The cardholder 120 may have a payment account issued by an issuing bank (associated with the issuer server 108) and may be provided the payment card with financial or other account information encoded onto the payment card such that the cardholder 120 may use the payment card to initiate and complete a transaction using a bank account at the issuing server 108.

The issuer server 108 is a computing server that is associated with the issuer bank. The issuer bank is a financial institution that manages accounts of multiple cardholders. Account details of the accounts established with the issuer bank are stored in cardholder profiles of the cardholders in a memory of the issuer server 108 or on a cloud server associated with the issuer server 108. The issuer server 108 approves or denies an authorization request, and then routes, via the payment network 114, an authorization response back to the acquirer server 102. The acquirer server 102 sends the approval message to the merchant device 106a.

Examples of the merchant device (e.g., merchant device 106a) and the user device include, but are not limited to, a personal computer (PC), a mobile phone, a tablet device, a Personal Digital Assistant (PDA), a voice-activated assistant, a Virtual Reality (VR) device, a smartphone, and a laptop.

The merchant 104a initiates a recurring payment transaction request for the cardholder 120 using the stored payment card information of the cardholder 120 to receive a recurring payment amount. However, sometimes, the recurring payment transaction request is declined by the issuer server 108 due to insufficient funds available in cardholder's account. Therefore, the merchant 104a needs to retry the recurring payment transaction again for the cardholder 120 for getting the payment transaction approved. Since the merchant 104a does not have any visibility of funds in the cardholder's account, therefore, a number of retrials may be required for receiving recurring payment amount.

Additionally, the server system 112 also does not have any prior information about whether a payment transaction requested by the merchant 104a will get approved, or not, and is not able to access information of the account balance/remaining credit limit for the cardholder 120. Therefore, to overcome this problem, the server system 112 is configured to access one or more customer spending features (i.e., spending pattern) associated with the cardholder 120 at one or more merchants and utilize statistical and machine learning models for predicting a time when the cardholder's account has a sufficient balance for the recurring payment amount. In particular, the server system 112 is configured to generate a likelihood score of being the card-on-file payment transaction getting approved within a particular time duration. In one embodiment, to reduce the number of retrials or to reduce the decline rate of recurring payment transactions, the server system 112 is configured to determine an optimal time window during which a probability of getting recurring payment transaction approved from the cardholder's account is greater than a threshold value.

The server system 112 is configured to provide a notification to the merchant 104a to attempt to receive the recurring payment amount from the cardholder's account during the optimal time window if the likelihood score is greater than the threshold value.

In one embodiment, the payment network 114 may be used by the payment cards issuing authorities as a payment interchange network. The payment network 114 may include a plurality of payment servers, such as the payment server 116. Examples of payment interchange network include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

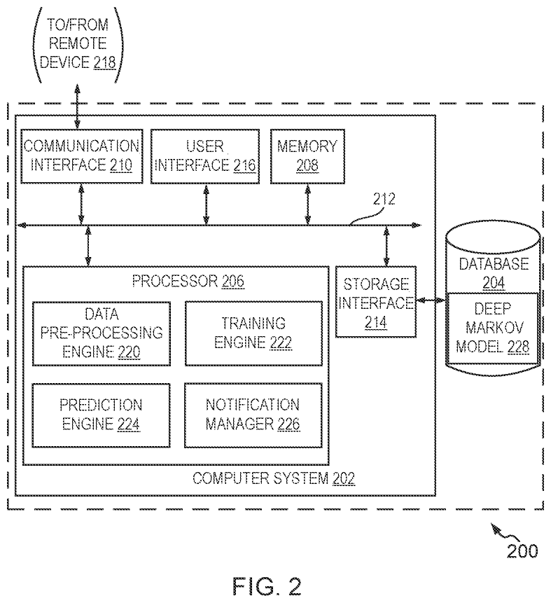

FIG. 2 is a simplified block diagram of a server system 200, in accordance with an embodiment of the present disclosure. The server system 200 is similar to the server system 112. In some embodiments, the server system 200 is embodied as a cloud-based and/or SaaS-based (software as a service) architecture. In one embodiment, the server system 200 is a part of the payment network 114 or integrated within the payment server 116. In another embodiment, the server system 200 is the acquirer server 102.

The server system 200 includes a computer system 202 and a database 204. The computer system 202 includes at least one processor 206 for executing instructions, a memory 208, a communication interface 210, and a user interface 216 that communicate with each other via a bus 212.

In some embodiments, the database 204 is integrated within computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 is configured to store the deep Markov model 228.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210 such that the processor 206 is capable of communicating with a remote device 218, such as the merchant device 106a, or communicated with any entity connected to the network 110 (as shown in FIG. 1). Further, the processor 206 is operatively coupled to the user interface 216 for interacting with merchants (e.g., the merchants 104a, 104b, and 104c) to assist the merchants in retrying the recurring payment transactions.

In one embodiment, when one or more merchants (e.g., merchant 104a) encounter a decline authorization response for a card-on-file payment transaction from the issuer server 108 associated with the cardholder 120. The processor 206 is configured to receive requests from the one or more merchants where each request includes cardholder's account details and a requested payment transaction amount by a merchant. In response, the processor 206 is configured to provide a probability of a successful card-on-file transaction in a particular time window (e.g., next 6 hours after first recurring transaction request decline) based on the cardholder's account details and the payment transaction amount requested by the respective merchant.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing engine 220, a training engine 222, a prediction engine 224, and a notification manager 226. It should be noted that components, described herein, can be configured in a variety of ways, including electronic circuitries, digital arithmetic and logic blocks, and memory systems in combination with software, firmware, and embedded technologies.

The data pre-processing engine 220 includes suitable logic and/or interfaces for accessing historical transaction data associated with the cardholder 120, periodically. The data pre-processing engine 220 is configured to capture customer spending features (i.e., customer spending characteristics) for each cardholder based, at least in part, on the historical transaction data. The customer spending features include, but are not limited to, customer spending at all aggregate merchants for a particular time duration (e.g., monthly, yearly), transaction velocity at all aggregate merchants, a median of total spend in a year, total transactions, a number of declined transactions, total transaction amount requested in declined transactions, a number of declined transactions, total amount requested in declined transaction due to insufficient funds, and total transactions at each industry. The data pre-processing engine 220 is configured to track payment transactions associated with the cardholder 120 performed at one or more merchants which in turn may be used to derive or generate customer feature vectors that are utilized for training a deep Markov model.

In one example, the data pre-processing engine 220 is configured to generate the customer spending features of the cardholder 120 for a band of the particular time window (e.g., 6 hours) within the past one year or two years to capture any seasonality effects in customer spending.

In one embodiment, the data pre-processing engine 220 is configured to perform featurization over the customer spending features (i.e., observable features) of the cardholder 120 to create customer feature vectors of the cardholder 120. In particular, the data pre-processing engine 220 is configured to convert one or more customer spending features into a low dimensional space using a dimensionality reduction autoencoder. In an embodiment, the customer feature vectors may help in determining the spending patterns of the cardholder 120 for whom one or more merchants may have faced the card-on-file transaction declines due to insufficient funds in the cardholder's account. The spending patterns may further help in training the statistical Markov model. In some embodiments, the autoencoder is configured to filter out noise, (i.e., irrelevant data) from high dimensional data associated with customer spending features.

The training engine 222 includes suitable logic and/or interfaces for training the deep Markov model based on customer spending features. In an embodiment, the deep Markov model is a hidden Markov model (HMM) with a variational inference structure. In one embodiment, the training engine 222 is configured to train the deep Markov model for predicting the likelihood score of being a recurring payment transaction request getting approved during the particular time window (e.g., next 6 hours after the first decline of the recurring payment transaction request, after x days).

Deep Markov models refer to the general class of Hidden Markov Models (HMMs), which are statistical models of sequences that have been used to model data in a variety of fields. Examples of fields include, but are not limited to, genomic modeling, financial modeling, etc. The sequences may be temporal, as in the example case of financial time-series data. The HMI is used for computing a probability for a sequence of observable events. In many cases, the events are hidden in nature. The HMM defines a probabilistic relationship between the observed events and hidden states. The HMMs are probabilistic frameworks where the observed data (such as, customer spending features) are modeled as a series of outputs (or emissions) generated by one of a plurality of (hidden) internal states. The HMM then uses inference algorithms to estimate the probability of each hidden state along with every position of the observed data.

It is understood that approval and decline of the card-on-file payment transactions are influenced by the amount balance available in the cardholder's account. The amount balance of the cardholder, however, cannot be directly observed and is thus considered a hidden state in the HMM. The hidden states may be considered to be a band of probable amount balance available in the cardholder's account. The payment transactions at one or more merchants performed by the cardholder 120 on a daily basis are observable events and are considered to be the outputs of the hidden states. These outputs, sometimes also referred to as emissions, are considered to be the result of a stochastic (i.e., randomly determined) process. The stochastic outputs of the hidden states have an associated probability distribution. For example, one may consider that on the daily basis, the payment transaction for a particular payment amount limit will be approved or declined. For example, when the band of probable amount balances of the cardholder 120 is within $200-$300, the probability distribution of getting a payment transaction of a payment amount $100 approved might be 80%. In contrast, when the band of probable amount balances of the cardholder 120 is within $100-$150, the probability distribution of getting a payment transaction of a payment amount $100 approved might be 30%. The transitions between the hidden states are also stochastic processes and are governed by a transition probability matrix.

In one embodiment, by utilizing the deep Markov model (DMM), the server system 200 is configured to learn whether a card-on-file transaction of a particular payment amount to the cardholder's account in the particular time window will get approved, or not. In one embodiment, the processor 206 is configured to design/create a plurality of hidden states in a latent space. Each hidden state is associated with a band of probable amount balance available in the cardholder's account.

Example of the bands of probable amount balance that can be created for the cardholder as follows:

$$\begin{matrix}S 0 \\ S 1 \\ S 2 \\ S 3 \\ S 4 \\ S 5 \\ S 6 \\ S 7 \\ S 8 \\ S 9 \\ S 10\end{matrix} = [ \begin{matrix}\$ 0 - 10 \\ \$ 10 - 20 \\ \$ 20 - 50 \\ \$ 50 - 100 \\ \$ 100 - 200 \\ \$ 200 - 300 \\ \$ 300 - 400 \\ \$ 400 - 500 \\ \$ 500 - 1000 \\ \$ 1000 - 10000 \\ > \$ 10000\end{matrix} ]$$

The training engine 222 is configured to identify a current hidden state based on customer feature vectors generated at a particular time. In one example, the cardholder 120 performs only one payment transaction of $22 to a grocery merchant from 9.00 AM to 12.00 PM on Sunday. The hidden state corresponding to that time duration will be S1. The processor 206 is also configured to update the hidden state associated with the cardholder 120 with every transaction at the merchants. More specifically, the training engine 222 is configured to use past approved and declined transaction information associated with the cardholder 120 for training the DMM.

The training engine 222 is configured to learn initial latent state probabilities, emissions probability distributions, and transition probability distributions from a set of training data. The set of training data includes, but is not limited to, customer spending features associated with the cardholder 120 of past time.

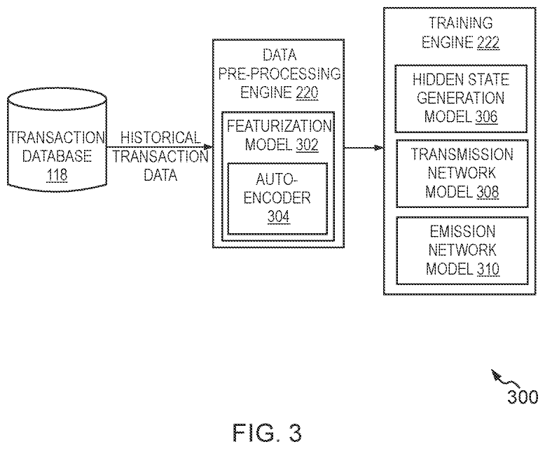

In one embodiment, parameters (such as, emission and transition probability distributions) of the DMM are parameterized through Long Short Term Memory (LSTM) network and learned through stochastic gradient descent algorithms based on the customer spending features corresponding to historical transaction data of the cardholder 120. The training process of the DMM is further explained in detail with reference to FIG. 3.

In one scenario, when the card-on-file payment transactions are declined for a number of merchants, the processor 206 is configured to learn the subsequent transition probabilities in the latent space based on the historical transaction data of the cardholder 120. An emission probability vector is generated having a length equal to the number of merchants on which the processor 206 is configured to find a probability of getting the next recurring transaction approved for each merchant.

The prediction engine 224 includes suitable logic and/or interfaces for predicting a likelihood score of being the card-on-file payment transaction getting approved within the particular time window based, at least in part, on a hidden state associated with the cardholder 120 and a pre-trained deep Markov model. The hidden state is determined based on the pre-trained deep Markov model and the payment amount. In one example, the payment amount associated with card-on-file transaction request is $29. Thus, the payment amount lies in a range of ‘S2’ hidden state (i.e., $20-$50).

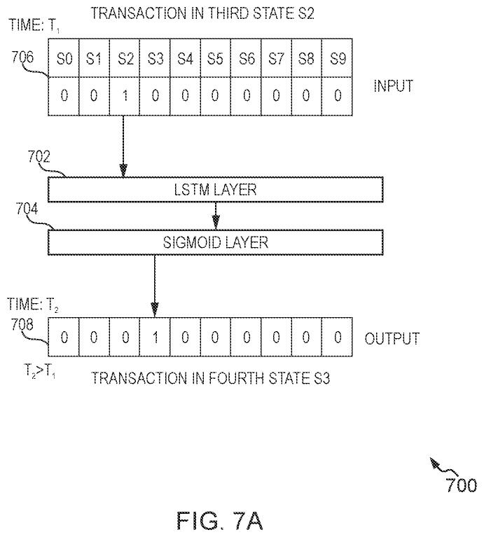

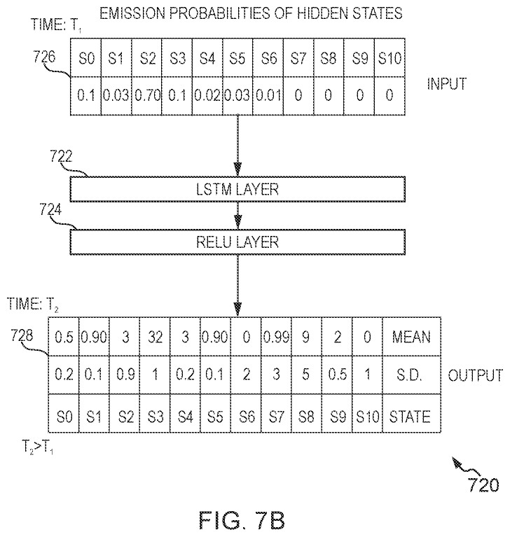

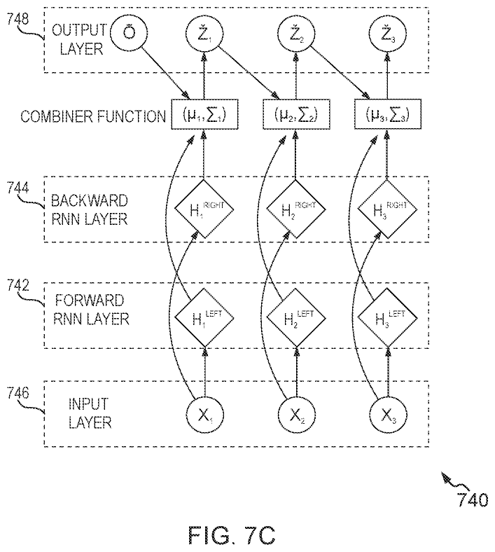

In an embodiment, the prediction engine 224 is configured to determine a current emission probability associated with the hidden state based, at least in part, on a variational neural network model. The variational neural network model includes a bi-directional LSTM network trained on past latent customer representation and previous emission probabilities of the plurality of hidden states. Detailed explanation of the variational neural network model is provided with reference to FIG. 7C. The current emission probability indicates an approval probability of a payment transaction at a particular time.

The prediction engine 224 is configured to determine the likelihood score of being the card-on-file payment transaction getting approved based at least on the current emission probability value associated with the hidden state within the particular time window and the payment amount requested by the merchant 104a in the card-on-file payment transaction.

In an alternate embodiment, when the likelihood score is not greater than a predetermined threshold value within the particular time window, the prediction engine 224 is configured to determine an optimal time at which the likelihood score of being the card-on-file payment transaction getting approved greater than the predetermined threshold value. In other words, the prediction engine 224 is configured to check whether the current emission probability associated with the hidden state is greater than the predetermined threshold value, or not.

In another embodiment, when the merchant 104a is not able to recover the whole payment amount, the server system is configured to check for lower payment amounts according to parameters set by the merchant 104a. The prediction engine 224 is configured to check current emission probabilities associated with one or more hidden states which are associated with bands of probable amount balance available lower than the requested payment amount. The prediction engine 224 is configured to identify another hidden state associated with a likelihood score greater than the predetermined threshold value and provide a notification to the merchant for retrying the card-on-file payment transaction for a partial payment amount which is less than the payment amount in lieu of an entirety of the payment amount.

The notification manager 226 includes suitable logic and/or interfaces for sending notifications to the merchants based on the calculated likelihood score of being the card-on-file payment transaction getting approved within a particular time window (e.g., 6 hours, 8 hours). Based on the notification, the merchant 104a retries for the card-on-file payment transaction of the cardholder 120.

In one embodiment, the server system 200 is configured to determine probabilities of getting successful card-on-file payment transactions for multiple merchants for a particular cardholder based on the respective requested payment amount.

For instance, an online video streaming merchant attempts to charge $29 as a monthly subscription fee to a cardholder who has already set up a card-on-file transaction relationship with the merchant. The merchant initiates a card-on-file transaction request of a payment amount $29 based on stored card details of the cardholder. Merchant bank sends an authorization request to an issuer associated with the cardholder through a payment network. The issuer checks cardholder's account balance and sends a card-on-file decline response to the merchant via the merchant bank when the cardholder's account does not have a sufficient balance for completing the card-on file transaction. Therefore, after encountering the first card-on-file decline for the cardholder by the merchant, the merchant sends a request to a server system for finding an optimal time for retrying the card-on-file transaction for the cardholder. The server system accesses a deep Markov model for the cardholder which was trained based on previous customer spending features of the cardholder. The server system predicts a hidden state of the DMM and estimates a current emission probability associated with the hidden state. Here, the current emission probability indicates a successful transaction. A likelihood score of being the card-on-file payment transaction getting approved within the next particular time window (e.g., 6 hours) is determined based on the current emission probability value and the payment amount (i.e., $29). Since the likelihood score (e.g., 0.6) is greater than a threshold value (i.e., 0.5), the server system provides a recommendation to the merchant for retrying the payment transaction of $29 from cardholder's account within the next 6 hours. Otherwise, the server system 200 provides the next optimal time for retrying the card-on-file payment transaction or determines a likelihood score of getting the card-on-file payment transaction approved with a partial payment amount.

FIG. 3 is a schematic block diagram representation 300 of a process flow for training the deep Markov model (DMM), in accordance with an example embodiment of the present disclosure.

As mentioned previously, at first, the processor 206 is configured to access historical transaction data associated with the cardholder 120 from the transaction database 118. The transaction database 118 is configured to store the historical transaction data associated with a payment card of the cardholder 120. The historical transaction data include, but are not limited to, total transactions performed at one or more merchants. In particular, the data pre-processing engine 220 is configured to receive the historical transaction data of cardholders with at least one card-on-file payment transaction decline during a particular time from the transaction database 118. The data pre-processing engine 220 is also configured to generate customer spending features for each cardholder based at least in part on the historical transaction data of the corresponding cardholder using a featurization model 302.

Once the customer spending features are created for each cardholder, the data pre-processing engine 220 is configured to convert the customer spending features of each cardholder into customer feature vectors for the corresponding cardholder. In one embodiment, the featurization model 302 is configured to perform dimensionality reduction of the customer feature vectors created for each cardholder using an autoencoder 304. The autoencoder 304 is configured to reduce the size of customer feature vectors by shrinking down the customer feature vectors to a smaller length.

The training engine 222 is configured to train the deep Markov model (DMM) for each cardholder based, at least in part, on associated customer feature vectors in past time. More specifically, the training engine 222 is configured to use past approved and declined transaction information associated with the cardholder 120 for training the deep Markov model. In general, the deep Markov model represents a chain of hidden states, with each hidden state in the chain conditioned on the previous hidden state. The DMM is specified by the following components:
S=S₀, S₁, S₂ . . . S_{N} a plurality of hidden states,
T=T₁₁, T₁₂ . . . T_{NN} a transition probability distribution,
X=X₁, X₂ . . . X_{M} a sequence of M observable events, each one drawn from a vocabulary of the hidden states,
B=bᵢ(Ok) a sequence of observation likelihoods (i.e., emission probabilities), where each emission probability represents a probability of an observation Ok being generated from a hidden state

The training engine 222 is configured to learn initial state probabilities, emissions probability distributions, and transition probability distributions from a set of training data. The set of training data includes, but is not limited to, customer spending features associated with the cardholder 120 for the past time.

The training engine 222 is configured to create, or design, a plurality of hidden states for each cardholder in a hidden space vector of the DMM using a hidden state generation model 306. In an embodiment, each hidden state in the plurality of hidden states is associated with a band of probable amount balance available in the payment account associated with the cardholder 120. The bands of probable amount balance are created based on the inputs provided by the administrators and/or merchants. Example of the bands of probable amount balances that can be created for the cardholder 120 are as follows:

$$\begin{matrix}S 0 \\ S 1 \\ S 2 \\ S 3 \\ S 4 \\ S 5 \\ S 6 \\ S 7 \\ S 8 \\ S 9 \\ S 10\end{matrix} = [ \begin{matrix}\$ 0 - 10 \\ \$ 10 - 20 \\ \$ 20 - 50 \\ \$ 50 - 100 \\ \$ 100 - 200 \\ \$ 200 - 300 \\ \$ 300 - 400 \\ \$ 400 - 500 \\ \$ 500 - 1000 \\ \$ 1000 - 10000 \\ > \$ 10000\end{matrix} ]$$

In one embodiment, the hidden state generation model 306 does not create or design hidden states with higher amount bands due to the fact that recurring transactions are not usually made on higher ticket size transactions. The vocabulary of the plurality of hidden states has been designed in such a way that the DMM outputs a probability corresponding to each amount band so that when the merchant requests for a particular amount for a specific cardholder, a probability score can be provided to the merchant. In one example, two card-on-file payment transactions are performed for a cardholder “A” at two different timestamps. At time T1, the cardholder “A” charges for grocery monthly subscription from a merchant X of $50 and at time T2, the cardholder “A” buys a service from a merchant Y of $500. In both observable events X1 and X2, payment transactions were approved. Both the observable events can be mapped to two different hidden (i.e., latent) states S₂ (i.e., $20-$50) and S₇ (i.e., $400-$500). It means that a band of the probable account balance of the cardholder 120 can be inferred from recent payment transactions performed by the cardholder 120 since the cardholder 120 cannot make a successful transaction until he/she has sufficient funds/credit limit for that particular transaction.

In one embodiment, the training engine 222 is configured to determine all the hidden states based on the past customer spending to one or more merchants at different timestamps. The training engine 222 is configured to estimate transition probability function and emission probability function using variational inference methods. In other words, the server system 200 is configured to first define types of probability distributions for the hidden states and the customer feature vectors (i.e., observation vector) and attempt to estimate parameters of the probability distributions using a neural network.

The training engine 222 includes a transmission network model 308 for determining a transition probability distribution for the plurality of hidden states of the DMM. For a hidden state, since each hidden state takes a binary value of one or zero, the transmission network model 308 is configured to estimate parameters of the transition probability distribution (i.e., P(zₜ|zₜ₋₁)) using Bernoulli distribution. Further, the transmission network model 308 is configured to output probabilities in a way such that the probability decreases monotonically from a lower band to a higher band.

The transmission network model 308 takes a sequence of a set of values of transition probability values of each of the hidden states as input and outputs the next set of values of the next transition probability values for the hidden states. The transmission network model utilizes an LSTM network followed by an array of sigmoid units that provide parameters for the respective Bernoulli distribution. Detailed explanation of the transmission network model 308 is provided with reference to the FIG. 7A. The transmission network model outputs the next set of values of the next transition probability values for the hidden states in a way such that the transition probability distribution decreases monotonically from a hidden state associated with a lower amount balance band to a hidden state associated with a higher amount balance band.

The training engine 222 also includes an emission network model 310 which is configured to determine emission probability distribution associated with observations using a Gaussian distribution with diagonal covariances.

The emission network model 310 takes a set of values of emission probabilities of each of the amount bands (i.e., hidden states) as an input and generates a set of mean and standard deviations of the customer spending features. In one embodiment, the emission network model 310 includes an LSTM network followed by an array of rectified linear unit (ReLU) units for determining parameters for the respective Gaussian distributions. Detailed explanation of the emission network model 310 is provided with reference to the FIG. 7B.

In one embodiment, the training engine 222 is configured to update/refresh the DMM for the cardholder 120 based on the customer spending on a timely basis.

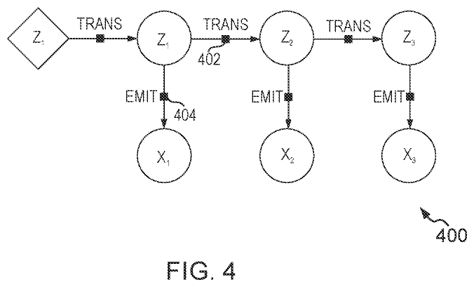

FIG. 4 is an example representation 400 of a structure of the deep Markov model (DMM), in accordance with example embodiments of the present disclosure.

A sequence of customer spending (i.e., observations) at different timestamps is represented in form of X₁, X₂, and X₃. The processor 206 is configured to identify a set of hidden states of the sequence of customer spending. In this example, the set of hidden states is represented in form of Z₁, Z₂, and Z₃. As mentioned previously, the set of hidden states represents a band of probable amount balance available in the cardholder's account. Each hidden state of the DMM is represented by the customer spending at all the merchants which is updated after every transaction that the cardholder 120 makes. Thus, a likelihood for the future card-on-file transactions to be successful at card-on-file merchants can be measured by a vector of emission probabilities learned through the DMM.

The solid black squares as shown in the FIG. 4 represent non-linear functions parameterized by neural networks. It is noted that the black squares appear in two different places: in between pairs of hidden variables (Zᵢ) and in between hidden variables (Zᵢ) and observations (Xᵢ). The non-linear function (i.e., transition probability function) that connects the hidden variables (see 402, ‘Trans’ in FIG. 4) controls the dynamics of the hidden variables. Since conditional probability distribution of Zₜ depends on Zₜ₋₁ in a complex way, the DMM captures complex dynamics using the transition probability distribution. Similarly, the non-linear function (i.e., emission probability function) connects the hidden variables to the observations (see 404, ‘Emit’ in FIG. 4) and controls how the observations, i.e., customer spending at one or more merchants depend on the latent dynamics, i.e., amount balance available in the cardholder's account.

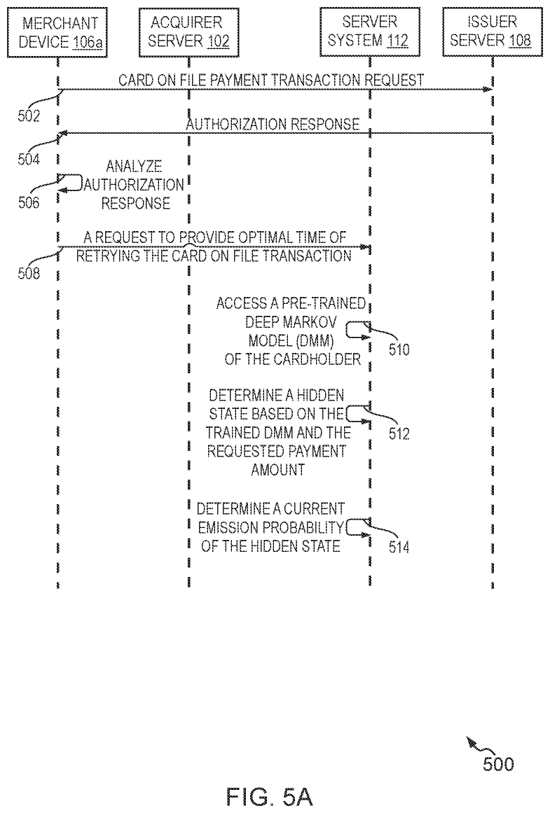

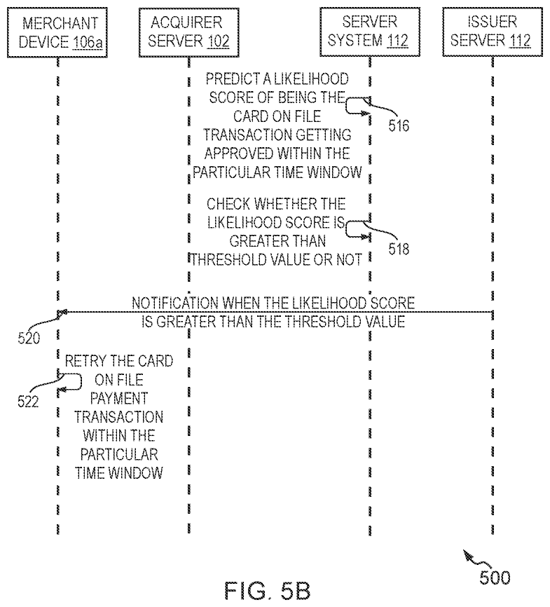

FIGS. 5A and 5B, collectively, represent a sequence flow diagram 500 for predicting a likelihood of being a card-on-file payment transaction request getting approved within a particular time window, in accordance with an example embodiment of the present disclosure. The sequence of operations of the flow chart 500 may not be necessarily executed in the same order as they are presented. Further, one or more operations may be grouped together and performed in the form of a single step, or one operation may have several sub-steps that may be performed in parallel or in a sequential manner.

At 502, a merchant (e.g., merchant 104a) sends a card-on-file payment transaction request for a cardholder 120 using a merchant device (e.g., merchant device 106a) to an issuer server 108 via the acquirer server 102. The cardholder 120 has already established card-on-file payment transaction relationship with the merchant 104a. The data relating to the cardholder 120 of a payment card may also be stored within a database associated with the merchant 104a. Such cardholder data may include, for example, the cardholder name and cardholder billing address. The card-on-file payment transaction request may include information about a payment account of the cardholder 120 and a payment amount to be paid to a merchant account of the merchant 104a. In one example, a merchant (e.g., a video streaming service provider) sends a request for a recurring payment transaction for a cardholder “A” of a payment amount of $79 to an acquirer and the acquirer sends the request to an issuer associated with the cardholder “A”.

In response, at 504, the issuer server 108 sends an authorization response to the merchant 104a via the acquirer server 102. The authorization response may be either ‘approved’, or ‘declined’. In one example, when the issuer server 108 declines the card-on-file payment transaction request, the issuer server 108 sends a decline reason code in the authorization response. In one example, the decline reason code indicates that the request is declined due to insufficient funds available in the payment account of the cardholder. In the above example, since the payment account of the cardholder “A” does not have a balance equal to or more than the requested payment amount, therefore, the recurring payment transaction request is declined.

At 506, the merchant 104a analyses the authorization response and decides whether to retry the card-on-file payment transaction for the same cardholder, or not. In one embodiment, the merchant 104a decides to send a request to the server system 112 to provide a recommendation about a retrial time for the card-on-file payment transaction.

At 508, the server system 112 receives a request from the merchant 104a for recommending an optimal retrial time for the card-on-file payment transaction. The request includes, but is not limited to, payment card details of the cardholder 120 and a requested payment amount in the card-on-file payment transaction. As mentioned in the example, the merchant also sends a request to the server system 112 for providing an optimal time for getting the card-on-file payment transaction approved.

At 510, the server system 112 accesses a pre-trained deep Markov model (DMM) associated with the cardholder 120. The DMM is trained based on past customer spending features associated with the cardholder 120. At 512, the server system 112 determines a hidden state based on the trained DMM and the requested payment amount. The hidden state is associated with a band of probable amount balances of the cardholder 120 that includes the requested payment amount as well. The server system 112 determines a hidden state associated with the band of probable amount balance including $29.

At 514, the server system 112 determines a current emission probability associated with the hidden state using a variational neural network model. The server system 112 predicts the current emission probability corresponding to the hidden state. The current emission probability indicates whether the payment transaction will get approved or declined within the particular time window.

At 516, the server system 112 predicts a likelihood score of being the card-on-file payment transaction getting approved within the particular time window based on the current emission probability value of the hidden state.

At 518, the server system 112 checks whether the likelihood score is greater than a predetermined threshold value, or not.

At 520, the server system 112 sends a notification when the likelihood score is greater than the predetermined threshold value. The notification includes a message for the merchant 104a whether to retry the card-on-file payment transaction from the payment account associated with the cardholder 120 within the particular time window, or not.

In one scenario, when the likelihood score is not greater than the predetermined threshold value, the server system 112 may check a likelihood of being the card-on-file payment transaction approved for partial payment amounts lower than the requested payment amount.

At 522, the merchant 104a retries the card-on-file payment transaction from the payment account associated with the cardholder 120 based on the notification, thereby reducing decline rates of card-on-file payment transaction due to insufficient funds availability in the cardholder's account.

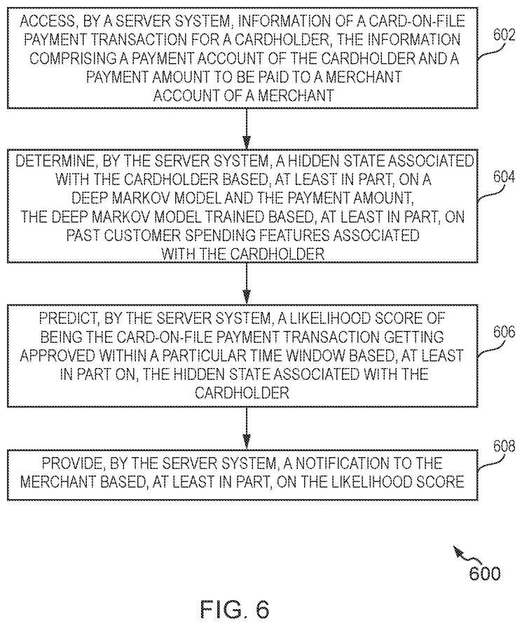

FIG. 6 is a flow diagram of a computer-implemented method 600 for predicting a likelihood score of being a card-on-file payment transaction getting approved, in accordance with an example embodiment of the present disclosure. The method 600 depicted in the flow diagram may be executed by the payment server 116 or the server system 112 as explained with reference to FIG. 1. Operations of the method 600, and combinations of operation in the method 600, may be implemented by, for example, hardware, firmware, a processor, circuitry and/or a different device associated with the execution of software that includes one or more computer program instructions. It is noted that the operations of the method 600 can be described and/or practiced by using a system other than the server systems. The method 600 starts at operation 602.

At the operation 602, the method 600 includes accessing information of a card-on-file payment transaction for a cardholder 120. The information includes a payment account of the cardholder 120 and a payment amount to be paid to a merchant account of a merchant 104a. The information is accessed after receiving a decline response for the card-on-file payment transaction from an acquirer associated with the merchant 104a and the decline response is received due to insufficient amount balance availability in the payment account of the cardholder 120. The information includes details associated with a payment account of the cardholder and a payment amount to be paid to a merchant account of a merchant.

At operation 604, the method 600 includes determining a hidden state associated with the cardholder 120 based, at least in part, on a pre-trained deep Markov model and the payment amount. The deep Markov model is trained based, at least in part, on past customer spending features associated with the cardholder. The deep Markov model is a hidden Markov model with a variational inference structure. Each hidden state of the deep Markov model represents a band of probable amount balance available in the payment account.

At operation 606, the method 600 includes predicting a likelihood score of being the card-on-file payment transaction getting approved within a particular time window based, at least in part. on the hidden state associated with the cardholder 120. In one embodiment, the method 600 includes predicting a current emission probability associated with the hidden state based, at least in part, on a variational neural network model. The variational neural network model is trained based, at least in part, on past latent customer representation and previous emission probabilities associated with the plurality of hidden states. The likelihood score is determined based at least on the current emission probability associated with the hidden state within the particular time window.

At operation 608, the method 600 includes providing, by the server system 112, a notification to the merchant based, at least in part, on the likelihood score. In one scenario, when the likelihood score is greater than the predetermined threshold value, the server system 112 provides instructions to retry the card-on-file payment transaction within the particular time window.

In another scenario, if the likelihood score is not greater than the predetermined threshold value, the server system 112 may determine and provide an optimal time duration, in which the card-on-file payment transaction will get approved, based on an emission probability value of the hidden state. In yet another scenario, the server system 200 may check current emission probabilities of one or more hidden states for the particular time window. The one or more hidden states correspond to bands of probable amount balance available in the payment account which are lower than the requested payment amount. When a current emission probability of a hidden state with higher amount balance band, but lower than the requested payment amount is greater than a threshold value, the server system 200 may notify the merchant for retrying the card-on-file payment transaction for a partial payment amount which is less than the payment amount in lieu of an entirety of the payment amount.

FIG. 7A shows an example representation 700 of a transmission network model, in accordance with an example embodiment of the present disclosure. As mentioned previously, the transmission network model is utilized for determining transition probability distribution for the plurality of hidden states of the DMM. Each hidden state corresponds to a band of probable amount balance of the cardholder 120. The transmission network model takes a sequence of a set of values of transition probability values of each hidden state as input and outputs of the next set of values of the next transition probability values for the plurality of hidden states.

As shown in the FIG. 7A, the transmission network model may include an LSTM layer 702 and a sigmoid layer 704. The input 706 of the LSTM layer 702 is a sequence of a set of values of transition probability values of the plurality of hidden states (S0, S1 . . . S9) associated with the time T1. The LSTM layer 702 provides latent space representation of the input to the sigmoid layer 704 to generate transition probability distribution of the plurality of hidden states associated with the time T2 (T2>T1) as an output 708. As shown in the FIG. 7A, at time T1, a payment transaction of a payment amount associated with a third state S2 has occurred. Based on the past learnings of state transitions, the transmission network model predicts that the payment transaction of payment amount associated with fourth state will occur at the time T2.

FIG. 7B shows an example representation 720 of an emission network model, in accordance with an example embodiment of the present disclosure. The emission network model may include an LSTM layer 722 and a rectified linear unit (ReLu) layer 724. The LSTM layer 722 and the ReLu layer 724 are configured to determine means and standard deviation values at time T2 corresponding to the customer spending features for each hidden state as an output 728 based on the an emission probability of each hidden state at time T1 as an input 726. As shown in the FIG. 7B, the emission network model takes emission probabilities of each hidden state as an input and generates means and standard deviation (S.D.) corresponding to each customer spending features underlying in each hidden state as an output.

FIG. 7C shows an example representation 740 of a variational neural network model for predicting current emission probability of each hidden state of the deep Markov model, in accordance with an example embodiment of the present disclosure. As mentioned previously, the variational neural network model includes bi-directional LSTM network trained on past latent customer representation of customer spending features and previous emission probabilities of the plurality of hidden states.

The variational neural network model includes forward RNN layer 742, backward RNN layer 744, input layer 746 and output layer 748. The input layer 746 arranges the past emission probabilities of each hidden state of the deep Markov model. The forward RNN layer 742 and the backward RNN layer 744 are configured to learn sequential patterns associated with the past emission probabilities of each hidden state of the DMM for the cardholder 120. The emission probability for a hidden state indicates whether the payment transaction is approved, or not. The learnings of the forward RNN layer 742 and the backward RNN layer 744 are combined to generate an output using the output layer 748. The output represents a current emission probability associated with each hidden state of the DMM.

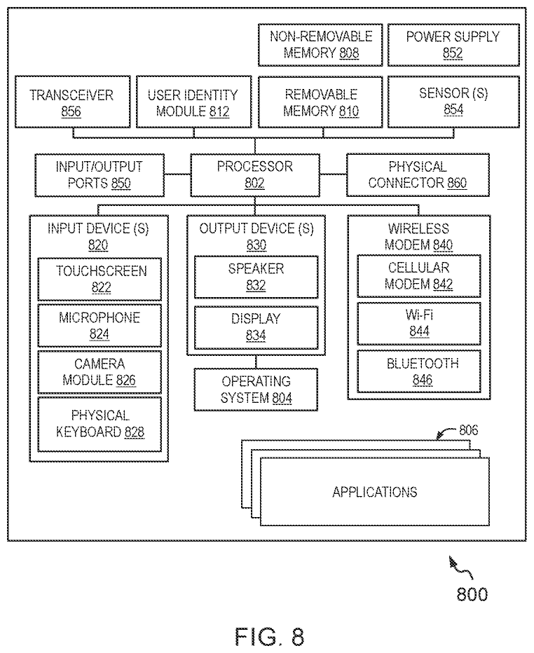

FIG. 8 shows a simplified block diagram of a user device 800, for example, a mobile phone or a desktop computer capable of implementing the various embodiments of the present disclosure. For example, the user device 800 may correspond to merchant devices associated with a plurality of merchants 104a, 104b, and 104c who will get notifications about when to retry the card-on-file payment transaction for a cardholder. In one example, the user device 800 is similar to the user device 122. The user device 800 is depicted to include one or more applications 806. The applications 806 can be an instance of an application downloaded from a third-party server.

It should be understood that the user device 800 as illustrated and hereinafter described is merely illustrative of one type of device and should not be taken to limit the scope of the embodiments. As such, it should be appreciated that at least some of the components described below in connection with the user device 800 may be optional and thus in an example embodiment may include more, less or different components than those described in connection with the example embodiment of the FIG. 8. As such, among other examples, the user device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the user device 800. In addition, the applications 806 may include common server performance monitoring applications or any other computing application.

The illustrated user device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The user device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols, such as Universal Mobile Telecommunications System (UMTS), CDMA9000, wideband CDMA (WCDMA) and time division-synchronous CDMA (TD-SCDMA), or with fourth-generation (4G) wireless communication protocols, such as LTE (Long-Term Evolution).

The user device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to, a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the user device 800 and a public switched telephone network (PSTN).

The user device 800 can further include one or more input/output ports 850, a power supply 852, one or more sensors 854, for example, an accelerometer, a gyroscope, a compass, or an infrared proximity sensor for detecting the orientation or motion of the user device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

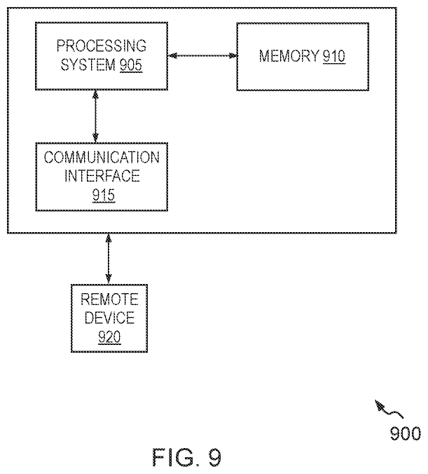

FIG. 9 is a simplified block diagram of a payment server 900, in accordance with an embodiment of the present disclosure. The payment server 900 is an example of the payment server 116 of FIG. 1. A payment network may be used by the payment server 900 as a payment interchange network. Examples of a payment interchange network include, but not limited to, Mastercard® payment system interchange network. The payment server 900 includes a processing system 905 configured to extract programming instructions from a memory 910 to provide various features of the present disclosure. Further, two or more components may be embodied in one single component, and/or one component may be configured using multiple sub-components to achieve the desired functionalities. Some components of the payment server 900 may be configured using hardware elements, software elements, firmware elements and/or a combination thereof. In one embodiment, the payment server 900 is configured to predict availability of sufficient funds in a cardholder's account within a particular time window.

Via a communication interface 915, the processing system 905 receives information from a remote device 920, such as the transaction database 118, merchant devices 106a, 106b and 106c, and the user device 122, or administrators managing server activities. The payment server 900 may also perform similar operations as performed by the server system 200 for predicting availability of sufficient funds in cardholder's account within a particular time window using one or more machine learning models. For the sake of brevity, the detailed explanation of the payment server 900 is omitted herein with reference to the FIG. 2.

The disclosed method with reference to FIG. 6, or one or more operations of the server system 200, may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
accessing, by a server system, information of a card-on-file payment transaction for a cardholder, the information comprising a payment account of the cardholder and a payment amount to be paid to a merchant account of a merchant;
determining, by the server system, a hidden state associated with the cardholder based, at least in part, on a deep Markov model and the payment amount, the deep Markov model trained based, at least in part, on past customer spending features associated with the cardholder;
predicting, by the server system, a likelihood score of being the card-on-file payment transaction getting approved within a particular time window based, at least in part, on the hidden state associated with the cardholder; and
providing, by the server system, a notification to the merchant based, at least in part, on the likelihood score.

2. The computer-implemented method as claimed in claim 1, wherein the hidden state of the deep Markov model represents a band of probable amount balance available in the payment account.

3. The computer-implemented method as claimed in claim 1, wherein predicting the likelihood score of being the card-on-file payment transaction getting approved comprises:
predicting, by the server system, a current emission probability associated with the hidden state within the particular time window based, at least in part, on a variational neural network model, the variational neural network model trained based, at least in part, on past latent customer representation and previous emission probabilities associated with a plurality of hidden states;
determining, by the server system, the likelihood score of being the card-on-file payment transaction getting approved based at least on the current emission probability associated with the hidden state within the particular time window; and
determining, by the server system, whether the likelihood score is greater than a predetermined threshold value, or not.

4. The computer-implemented method as claimed in claim 3, further comprising:
in response to determining that the likelihood score is greater than the predetermined threshold value, providing, by the server system, the notification to the merchant, the notification comprising a message for retrying the card-on-file payment transaction from the payment account associated with the cardholder within the particular time window.

5. The computer-implemented method as claimed in claim 3, further comprising:
in response to determining that the likelihood score is not greater than the predetermined threshold value, determining, by the server system, an optimal time duration in which the likelihood score of being the card-on-file payment transaction getting approved is greater than the predetermined threshold value; and
providing, by the server system, the notification to the merchant, the notification comprising a message for retrying the card-on-file payment transaction from the payment account associated with the cardholder in the optimal time duration.

6. The computer-implemented method as claimed in claim 3, further comprising:
in response to determining that the likelihood score is not greater than the predetermined threshold value, checking, by the server system, current emission probabilities associated with one or more hidden states, the one or more hidden states corresponding to bands of probable amount balance available in the payment account which are lower than the requested payment amount;
identifying, by the server system, another hidden state associated with another current emission probability value greater than the predetermined threshold value, from the one or more hidden states; and
providing, by the server system, the notification to the merchant, the notification comprising a message for retrying the card-on-file payment transaction for a partial payment amount which is less than the payment amount in lieu of an entirety of the payment amount.

7. The computer-implemented method as claimed in claim 1, wherein the customer spending features include one or more of:
total spends at one or more merchants;
transaction velocities at all aggregate merchants;
a number of declined transactions and total transaction amount requested in declined transactions;
the number of declined transactions and total amount requested in the declined transaction due to insufficient funds in the payment account of the cardholder; and
total transactions in each industry.

8. The computer-implemented method as claimed in claim 1, wherein the server system is a payment server associated with a payment network.

9. The computer-implemented method as claimed in claim 1, wherein the information is accessed after receiving a decline response for the card-on-file payment transaction from an acquirer, and wherein the decline response for the card-on-file payment transaction is received due to insufficient amount balance availability in the payment account of the cardholder.

10. A server system, comprising:
a communication interface;
a memory comprising executable instructions; and
a processor communicably coupled to the communication interface, the processor configured to execute the executable instructions to cause the server system to at least:
access information of a card-on-file payment transaction for a cardholder, the information comprising a payment account of the cardholder and a payment amount to be paid to a merchant account of a merchant;
determine a hidden state associated with the cardholder based, at least in part, on a deep Markov model and the payment amount, the deep Markov model trained based, at least in part, on past customer spending features associated with the cardholder;
predict a likelihood score of being the card-on-file payment transaction getting approved within a particular time window based, at least in part, on the hidden state associated with the cardholder; and
provide a notification to the merchant based, at least in part, on the likelihood score.

11. The server system as claimed in claim 10, wherein each hidden state of the deep Markov model represents a band of probable amount balance available in the payment account.

12. The server system as claimed in claim 10, wherein, to predict the likelihood score of being the card-on-file payment transaction getting approved, the server system is further caused, at least in part, to:
predict a current emission probability associated with the hidden state within the particular time window based, at least in part, on a variational neural network model, the variational neural network model trained based, at least in part, on past latent customer representation and previous emission probabilities associated with a plurality of hidden states,
determine the likelihood score of being the card-on-file payment transaction getting approved based at least on the current emission probability associated with the hidden state within the particular time window, and
determine whether the likelihood score being greater than a predetermined threshold value, or not.

13. The server system as claimed in claim 12, wherein the server system is further caused, at least in part, to:
in response to a determination that the likelihood score is greater than the predetermined threshold value, provide the notification to the merchant, the notification comprising a message for retrying the card-on-file payment transaction from the payment account associated with the cardholder within the particular time window.

14. The server system as claimed in claim 12, wherein the server system is further caused, at least in part, to:
in response to a determination that the likelihood score is not greater than the predetermined threshold value, determine an optimal time duration in which the likelihood score of being the card-on-file payment transaction getting approved is greater than the predetermined threshold value, and
provide the notification to the merchant, the notification comprising a message for retrying the card-on-file payment transaction from the payment account associated with the cardholder in the optimal time duration.

15. The server system as claimed in claim 12, wherein the server system is further caused, at least in part, to:
in response to a determination that the likelihood score is not greater than the predetermined threshold value, check current emission probabilities associated with one or more hidden states, the one or more hidden states corresponding to the bands of probable amount balance available in the payment account which are lower than the requested payment amount;
identify another hidden state associated with another current emission probability value greater than the predetermined threshold value, from the one or more hidden states; and
provide the notification to the merchant, the notification comprising a message for retrying the card-on-file payment transaction for a partial payment amount which is less than the payment amount in lieu of an entirety of the payment amount.

16. The server system as claimed in claim 10, wherein the server system is a payment server associated with a payment network.

17. A computer-implemented method, comprising:
accessing, by a server system, information of a card-on-file payment transaction for a cardholder, the information comprising a payment account of the cardholder and a payment amount to be paid to a merchant account of a merchant;
determining, by the server system, a hidden state associated with the cardholder based, at least in part, on a pre-trained deep Markov model and the payment amount, the pre-trained deep Markov model trained based, at least in part, on past customer spending features associated with the cardholder;
predicting, by the server system, a likelihood score of being the card-on-file payment transaction getting approved within a particular time window based, at least in part, on the hidden state associated with the cardholder; and
providing, by the server system, a notification to the merchant based, at least in part, on the likelihood score;
wherein each hidden state of the pre-trained deep Markov model represents a band of probable amount balance available in the payment account.

18. The computer-implemented method as claimed in claim 17, wherein predicting the likelihood score of being the card-on-file payment transaction getting approved comprises:
predicting, by the server system, a current emission probability associated with the hidden state within the particular time window based, at least in part, on a variational neural network model, the variational neural network model trained based, at least in part, on past latent customer representation and previous emission probabilities associated with a plurality of hidden states;
determining, by the server system, the likelihood score of being the card-on-file payment transaction getting approved based at least on the current emission probability associated with the hidden state within the particular time window; and
determining, by the server system, whether the likelihood score is greater than a predetermined threshold value, or not.

19. The computer-implemented method as claimed in claim 18, further comprising:
in response to determining the likelihood score to be greater than the predetermined threshold value, providing, by the server system, the notification to the merchant, the notification comprising a message for retrying the card-on-file payment transaction from the payment account associated with the cardholder within the particular time window.

20. The computer-implemented method as claimed in claim 17, wherein the past customer spending features include one or more of:
total spends at one or more merchants;
transaction velocities at all aggregate merchants;
a number of declined transactions and total transaction amount requested in declined transactions;
a number of declined transactions and total amount requested in declined transaction due to insufficient funds in the payment account of the cardholder; and
total transactions in each industry.
